(19) United States
(12) Patent Application Publication
(10) Pub. No.: US 2022/0338154 A1
(43) Pub. Date: Oct. 20, 2022

(54) ENHANCEMENTS ON VOICE DOMAIN MANAGEMENT (VDM) FOR IP MULTIMEDIA SUBSYSTEM (IMS) VOICE PROVIDED OVER A 5G NETWORK

(71) Applicant: MediaTek Singapore Pte. Ltd., Singapore (SG)

(72) Inventors: Marko NIEMI, Oulu (FI); Chien-Chun HUANG-FU, Hsinchu City (TW)

(21) Appl. No.: 17/702,316

(22) Filed: Mar. 23, 2022

Related U.S. Application Data
(60) Provisional application No. 63/174,709, filed on Apr. 14, 2021.

(51) Int. Cl. H04W 60/04; H04W 48/20; H04L 65/1016

(52) U.S. Cl. CPC H04W 60/04; H04W 48/20; H04L 65/1016; H04W 84/042

(57) ABSTRACT

A method for a User Equipment (UE) to enhance Voice Domain Management (VDM) for IP Multimedia Subsystem (IMS) voice provided over a 5G network is provided. The UE receives an indication that causes it to not disable the Evolved-Universal Terrestrial Radio Access (E-UTRA) capability for a Public Land Mobile Network (PLMN), before or after selecting a Next Generation-Radio Access Network (NG-RAN) cell in the PLMN with the UE's usage setting being set to voice centric. The UE enables the E-UTRA capability or keeps the E-UTRA capability enabled in response to the indication.

### CROSS REFERENCE TO RELATED APPLICATIONS

This application claims priority under 35 U.S.C. § 119 from U.S. Provisional Application No. 63/174,709, entitled “UE and network improvements when IMS voice provided over a 5G network”, filed on Apr. 14, 2021, the subject matter of which is incorporated herein by reference.

### BACKGROUND OF THE APPLICATION

### Field of the Application

The application generally relates to mobile communications, and more particularly, to enhancements on Voice Domain Management (VDM) for IP Multimedia Subsystem (IMS) voice provided over a 5G network.

### Description of the Related Art

In a typical mobile communication environment, a UE (also called a Mobile Station (MS)), such as a mobile telephone (also known as a cellular or cell phone) or a tablet Personal Computer (PC) with wireless communication capability, may communicate voice and/or data signals with one or more mobile communication networks. The wireless communication between the UE and the mobile communication networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc. In particular, GSM/GPRS/EDGE technology is also called 2G technology; WCDMA/CDMA-2000/TD-SCDMA technology is also called 3G technology; and LTE/LTE-A/TD-LTE technology is also called 4G technology.

These RAT technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

According to the 3GPP specifications in compliance with the 5G technology, a 5G network may indicate that IMS Voice over Packet-Switched (VoPS) session is supported to a voice-centric UE when IMS VoPS is natively provided by the 5G network or when IMS VoPS is provided over Evolved Packet System (EPS). When IMS VoPS is actually provided over EPS, the 5G network can indicate “IMS VoPS is supported” only if the UE has provided the 5G network with information that it supports the S1-mode capability (i.e., the Evolved-Universal Terrestrial Radio Access (E-UTRA) capability). However, since the UE is not aware whether IMS VoPS is provided by the 5G network or is provided over EPS, the user of the UE may switch off the S1-mode capability after it has registered to the 5G network in which IMS VoPS is actually provided over EPS. As a result, the UE may be redirected to find a 2G/3G network instead to obtain voice service, but the data rate of the 2G/3G network is expected to be much lower than that of the 5G network. This may critically impact user experience, especially when the user often uses the UE for data service.

A solution is sought.

### BRIEF SUMMARY OF THE APPLICATION

In a first aspect of the application, a method for a User Equipment (UE) to enhance VDM for IMS voice provided over a 5G network is provided. The method comprises the following steps: receiving, by a UE, an indication causing the UE to not disable an Evolved-Universal Terrestrial Radio Access (E-UTRA) capability for a Public Land Mobile Network (PLMN), before or after selecting a Next Generation-Radio Access Network (NG-RAN) cell in the PLMN with the UE's usage setting being set to voice centric; and enabling the E-UTRA capability or keeping the E-UTRA capability enabled in response to the indication.

In a second aspect of the application, a UE comprising a wireless transceiver and a controller is provided. The wireless transceiver is configured to perform wireless transmission and reception to and from a PLMN. The controller is communicatively coupled to the wireless transceiver such that, during operation, the controller performs operations comprising: receiving an indication causing the UE to not disable an E-UTRA capability for the PLMN, before or after selecting an NG-RAN cell in the PLMN with the UE's usage setting being set to voice centric; and enabling the E-UTRA capability or keeping the E-UTRA capability enabled in response to the indication.

In one example, the enabling of the E-UTRA capability is performed in a condition that the E-UTRA capability is disabled for the PLMN. The UE may de-register from the PLMN and re-register to the PLMN with the E-UTRA capability enabled, or it may initiate a Mobility Registration Update (MRU) procedure to update the E-UTRA capability from disabled to enabled.

In one example, the keeping of the E-UTRA capability enabled is performed in a condition that the E-UTRA capability is enabled for the PLMN.

In one example, the indication indicates that IP Multimedia Subsystem (IMS) voice is served over Evolved Packet System (EPS) in the PLMN, or indicates whether Voice over New Radio (VoNR) is supported for IMS voice in the PLMN.

In one example, the UE receives another indication that the PLMN supports IMS voice over Packet Switched (PS) session over Third Generation Partnership Project (3GPP) access, when the E-UTRA capability is enabled for the PLMN. In another example, the UE receives another indication that the PLMN does not support IMS Voice over PS session over 3GPP access, when the E-UTRA capability is disabled for the PLMN.

In one example, the indication is received from the PLMN via a Non-Access Stratum (NAS) configuration Management Object (MO).

In one example, the indication is received from the PLMN via a NAS message which comprises a REGISTRATION ACCEPT message, a SERVICE ACCEPT message, or a CONFIGURATION UPDATE COMMAND message, or via an AS message.

In one example, the indication is received from a Universal Subscriber Identity Module (USIM) file configured for the PLMN.

In one example, the indication is received via an Attention (AT) command interface, and the indication comprises information on whether the PLMN supports VoNR or not.

In a third aspect of the application, a method for a PLMN to enhance VDM for IMS voice provided over a 5G network is provided. The method comprises the following steps: serving a UE on an NG-RAN cell by a PLMN, wherein the UE's usage setting is set to voice centric; and sending an indication to cause the UE to not disable an E-UTRA capability for the PLMN.

In one example, the PLMN sends another indication that the PLMN supports IMS voice over PS session over 3GPP access, when the E-UTRA capability is enabled for the PLMN. In another example, the PLMN sends another indication that the PLMN does not support IMS voice over PS session over 3GPP access, when the E-UTRA capability is disabled for the PLMN.

In one example, the indication indicates that IMS voice is served over EPS in the PLMN, or indicates whether VoNR is supported for IMS voice in the PLMN.

In one example, the indication is sent to the UE via a NAS configuration MO.

Other aspects and features of the present application will become apparent to those with ordinary skill in the art upon review of the following descriptions of specific embodiments of the UEs and methods for enhancing VDM for IMS voice provided over a 5G network.

### BRIEF DESCRIPTION OF DRAWINGS

The application can be more fully understood by reading the subsequent detailed description and examples with references made to the accompanying drawings, wherein:

FIG. 1 is a block diagram of a mobile communication environment according to an embodiment of the application;

FIG. 2 is a block diagram illustrating a UE according to an embodiment of the application;

FIG. 3 is a message sequence chart illustrating the provision of an additional indication to enhance Voice Domain Management (VDM) for IMS voice provided over 5G network according to an embodiment of the application;

FIG. 4 is a message sequence chart illustrating the provision of an additional indication to enhance the VDM for IMS voice provided over 5G network according to another embodiment of the application;

FIG. 5 is a message sequence chart illustrating the provision of an additional indication to enhance the VDM for IMS voice provided over 5G network according to yet another embodiment of the application;

FIG. 6 is a flow chart illustrating the method for a UE to enhance VDM for IMS voice provided over 5G network according to an embodiment of the application; and

FIG. 7 is a flow chart illustrating the method for a PLMN to enhance VDM for IMS voice provided over a 5G network according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

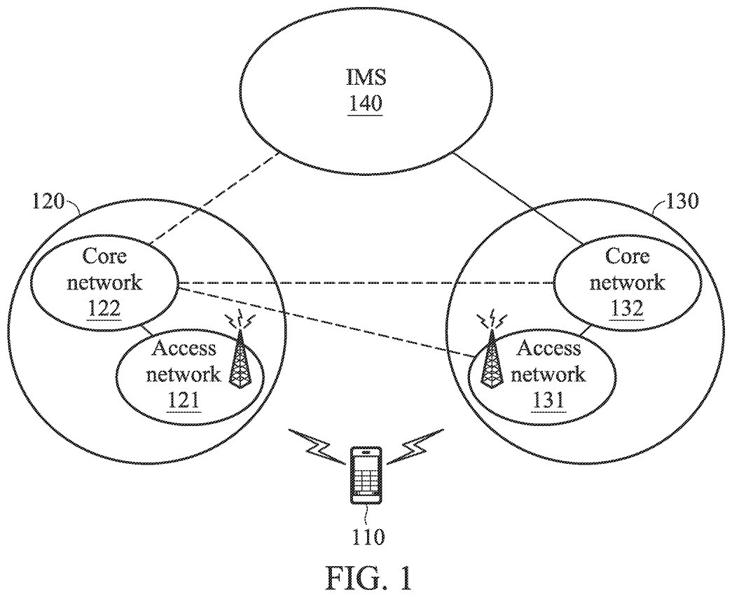

FIG. 1 is a block diagram of a mobile communication environment according to an embodiment of the application.

As shown in FIG. 1, the mobile communication environment 100 includes a UE 110, two mobile communication networks 120 and 130, and an IMS network 140.

The UE 110 may be a feature phone, a smartphone, a panel Personal Computer (PC), a laptop computer, a Machine Type Communication (MTC) device, or any mobile communication device supporting the RATs utilized by the mobile communication networks 120 and 130. In one example, the UE 110 is configured to be a voice-centric UE, i.e., the UE's usage setting is set to “voice centric”, meaning voice service is more important to the UE and the UE should always try to ensure that voice service is available in the currently registered Public Land Mobile Network (PLMN).

The mobile communication networks 120 and 130 may each belong to a respective PLMN, or may both belong to the same PLMN. The mobile communication network 120 includes an access network 121 and a core network 122, while the mobile communication network 130 includes an access network 131 and a core network 132. Each of the access networks 121 and 131 is responsible for processing radio signals, terminating radio protocols, and connecting the UE 110 with the core network 122/132, while each of the core networks 122 and 132 is responsible for performing mobility management, network-side authentication, and interfaces with public/external networks (e.g., the IMS network 140 and/or the Internet).

In one example, the mobile communication network 120 is a 5G network (e.g., an NR network, also called a 5G System (5GS)), and the access network 121 and the core network 122 are a Next Generation Radio Access Network (NG-RAN) and a Next Generation Core Network (NG-CN) (or called 5G Core (5GC)), respectively. The NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases. The NG-CN may support various network functions, including an Access and Mobility Management Function (AMF), a Session Management Function (SMF), a User Plane Function (UPF), a Policy Control Function (PCF), an Application Function (AF), an Authentication Server Function (AUSF), and a Non-3GPP Inter-Working Function (N3IWF), wherein each network function may be implemented as a network element on dedicated hardware, or as a software instance running on dedicated hardware, or as a virtualized function instantiated on an appropriate platform, e.g., a cloud infrastructure.

In one example, the mobile communication network 130 is a 4G network (e.g., an LTE/LTE-A/TD-LTE network, also called an Evolved Packet System (EPS)), and the access network 131 and the core network 132 are an Evolved-Universal Terrestrial Radio Access Network (E-UTRAN) and an Evolved Packet Core (EPC), respectively. The E-UTRAN may include at least an evolved NodeB (eNB) (e.g., a macro eNB, femto eNB, or pico eNB). The EPC may include a Home Subscriber Server (HSS), Mobility Management Entity (MME), Serving Gateway (S-GW), and Packet Data Network Gateway (PDN-GW or P-GW).

The IMS network 140 is a call service system consisting of various network functions for providing Internet Protocol (IP) multimedia services to the UE 110 over the mobile communication network 120/130. The IP multimedia services provided by the IMS network 140 at least includes call services, such as Voice over LTE (VoLTE), Video over LTE (ViLTE), Voice over NR (VoNR), Video over NR (ViNR), and voice over E-UTRA by 5GC, etc. In addition, the IP multimedia services may also include data services, such as Short Message Service (SMS) over IMS, Mission Critical Push To Talk (MCPTT), Mission Critical Video (MCVideo), Mission Critical Data (MCData), Rich Communication Services (RCS), XML Configuration Access Protocol (XCAP), and others.

Please note that the interface between the core networks 122 and 132, the interface between the core network 122 and the access network 131, and the interface between the core network 122 and the IMS network 140 may be optional or mandatory (denoted as dashed lines in FIG. 1) depending on the network deployment scenario. For example, the interface between the core network 122 and the IMS network 140 is mandatory if the mobile communication network 120 supports VoNR; the interface between the core network 122 and the access network 131 is mandatory if the mobile communication network 120 supports voice over E-UTRA by 5GC; or the interface between the core networks 122 and 132 is mandatory if the mobile communication network 120 only supports VoLTE.

In accordance with one novel aspect, the mobile communication network 120 may provide a new indication to inform the UE 110 that IMS voice is serviced over EPS or VoNR is supported, in addition to the indication that IMS VoPS session over 3GPP access is supported, so that the UE 110 may react to the new indication by not disabling the E-UTRA capability for the PLMN to which the mobile communication network 120 belongs.

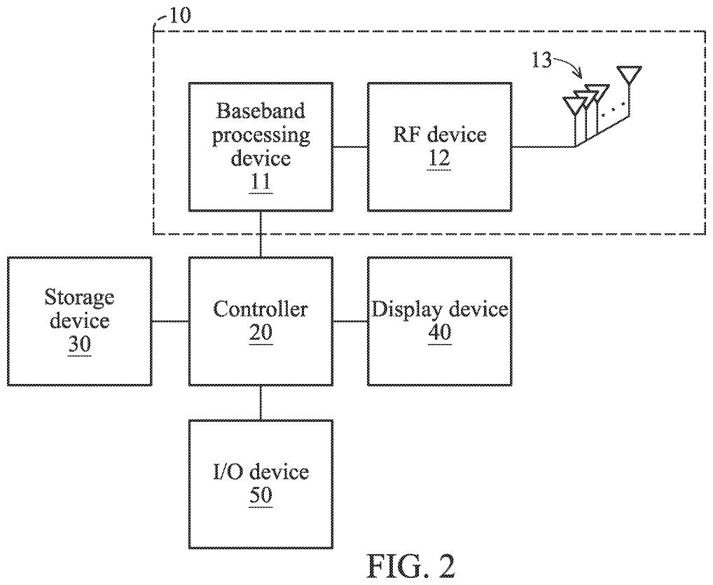

FIG. 2 is a block diagram illustrating a UE according to an embodiment of the application.

As shown in FIG. 2, a UE (e.g., the UE 110) may include a wireless transceiver 10, a controller 20, a storage device 30, a display device 40, and an Input/Output (I/O) device 50.

The wireless transceiver 10 is configured to perform wireless transmission and reception to and from one or both of the mobile communication networks 120 and 130.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between Subscriber Identity Module (SIM) or Universal SIM (USIM) card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may include a mixer to multiply the baseband signals with a carrier oscillated in the radio frequency of the supported RATs, wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the service network 120, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 to perform the method of the present application.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., the guard timer value), instructions, and/or program code of applications, communication protocols, and/or the method of the present application. In one example, the method of the present application may be implemented as part of the communication protocols which may include a SIP signaling protocol, a 4G LTE protocol stack, and a 5G NR protocol stack. A 4G/5G protocol stack generally may include a Non-Access-Stratum (NAS) layer to communicate with an AMF/SMF/MME entity connecting to the core network 122/132, a Radio Resource Control (RRC) layer for high layer configuration and control, a Packet Data Convergence Protocol/Radio Link Control (PDCP/RLC) layer, a Media Access Control (MAC) layer, and a Physical (PHY) layer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, the UE may not include the display device 40 and/or the I/O device 50.

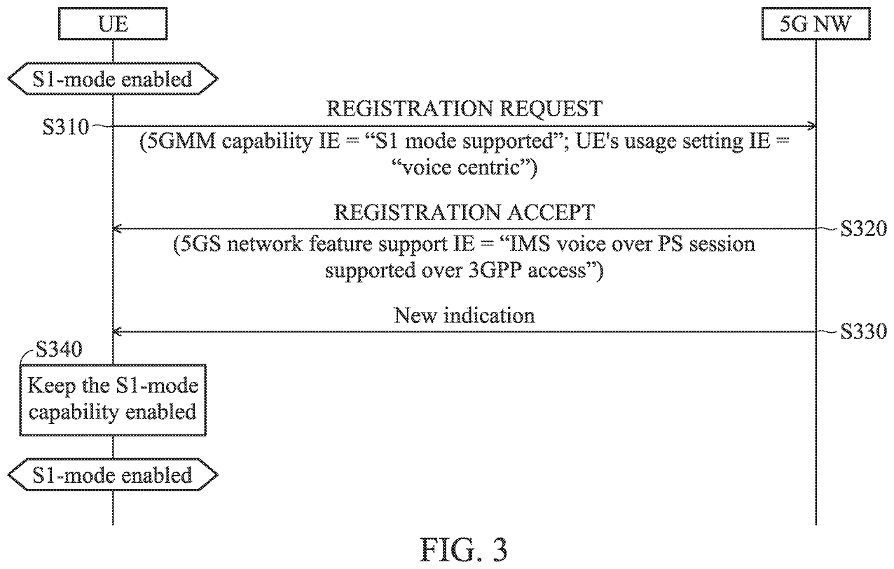

FIG. 3 is a message sequence chart illustrating the provision of an additional indication to enhance Voice Domain Management (VDM) for IMS voice provided over a 5G network according to an embodiment of the application.

In this embodiment, the S1-mode capability (i.e., the E-UTRA capability) of the UE is initially enabled.

In step S310, the UE selects an NG-RAN of a 5G network belonging to a PLMN and performs the registration procedure with the 5G network, by sending a REGISTRATION REQUEST message to the 5G network. Specifically, the UE sets the S1 mode bit to “S1 mode supported” in the 5GMM capability Information Element (IE) of the REGISTRATION REQUEST message, and sets the UE's usage setting IE to “voice centric” in the REGISTRATION REQUEST message.

In step S320, the UE receives a REGISTRATION ACCEPT message from the 5G network. Specifically, the IMS-VoPS-3GPP indicator is set to “IMS voice over PS session supported over 3GPP access” in 5GS network feature support IE of the REGISTRATION ACCEPT message.

In step S330, the UE receives a new indication that IMS voice is served over EPS in the PLMN, or whether VoNR is supported for IMS voice in the PLMN. In one example, the new indication may be received via a NAS configuration Management Object (MO). In another example, the new indication may be received from a USIM file configured for the PLMN. In yet another example, the new indication may be received via an AS message or a NAS message, such as a REGISTRATION ACCEPT message, a SERVICE ACCEPT message, or a CONFIGURATION UPDATE COMMAND message. Alternatively, the new indication may be included in the REGISTRATION ACCEPT message in step S320 (e.g., “VoPS served over EPS only” or “EPS to be enabled for VoPS”, or “EPS FB supported” in the 5GS network feature support IE), and step S330 may be omitted.

In step S340, the UE keeps the S1-mode capability enabled. In one example, the UE may further hint the user (e.g., via sending an indication to the application layer) to keep the S1-mode capability enabled (i.e., to not disable the S1-mode capability).

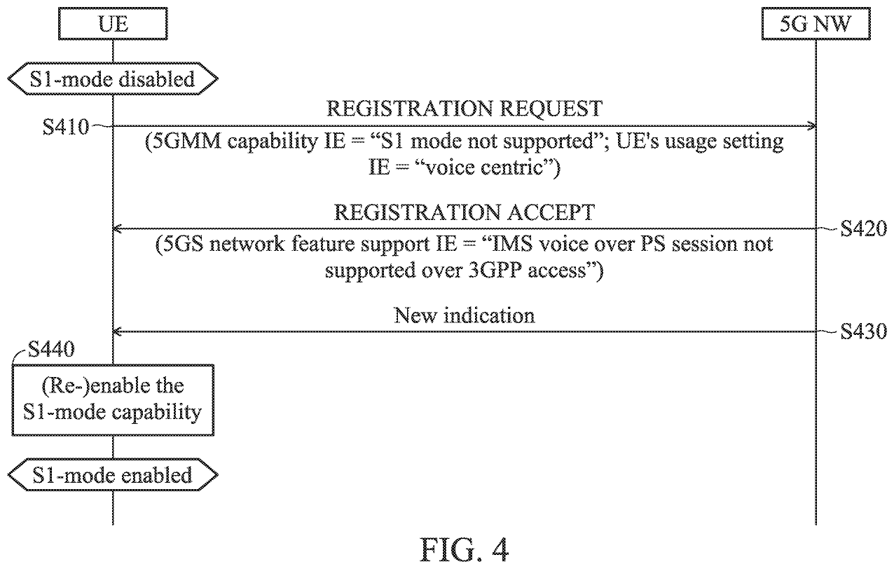

FIG. 4 is a message sequence chart illustrating the provision of an additional indication to enhance the VDM for IMS voice provided over a 5G network according to another embodiment of the application.

In this embodiment, the S1-mode capability (i.e., the E-UTRA capability) of the UE is initially disabled.

In step S410, the UE selects an NG-RAN of a 5G network belonging to a PLMN and performs the registration procedure with the 5G network, by sending a REGISTRATION REQUEST message to the 5G network. Specifically, the UE sets the S1 mode bit to “S1 mode not supported” in the 5GMM capability IE of the REGISTRATION REQUEST message, and sets the UE's usage setting IE to “voice centric” in the REGISTRATION REQUEST message.

In step S420, the UE receives a REGISTRATION ACCEPT message from the 5G network. Specifically, the IMS-VoPS-3GPP indicator is set to “IMS voice over PS session not supported over 3GPP access” in 5GS network feature support IE of the REGISTRATION ACCEPT message. In another embodiment for step S420, the UE may receive a REGISTRATION REJECT message from the 5G network, wherein the reception of the REGISTRATION REJECT message means that the registration procedure with the 5G network fails and the UE may need to re-perform the registration procedure later. In the REGISTRATION REJECT message, the network may provide a new indication that IMS voice is served over EPS in the PLMN, or whether VoNR is supported for IMS voice in the PLMN.

In step S430, the UE receives a new indication that IMS voice is served over EPS in the PLMN, or whether VoNR is supported for IMS voice in the PLMN. In one example, the new indication may be received via a NAS configuration MO. In another example, the new indication may be received from a USIM file configured for the PLMN. In yet another example, the new indication may be received via the Attention (AT) command interface with PLMNs and corresponding voice configuration information (e.g., PLMN A supports VoNR, PLMN B supports voice over fallback to EPS, etc.). In still another example, the new indication may be received via an AS message or a NAS message, such as a REGISTRATION ACCEPT message, a SERVICE ACCEPT message, or a CONFIGURATION UPDATE COMMAND message. Alternatively, the new indication may be included in the REGISTRATION ACCEPT message in step S420 (e.g., “VoPS served over EPS only” or “EPS to be enabled for VoPS”, or “EPS FB supported” in the 5GS network feature support IE), and step S430 may be omitted.

In step S440, the UE (re-)enables the S1-mode capability. In one example, the UE may (re-)enables the S1-mode capability by de-registering from the 5G network and then re-registering to the 5G network with the S1-mode capability being enabled (e.g., set the S1 mode bit to “S1 mode supported” in the 5GMM capability IE of a new REGISTRATION REQUEST message). In another example, the UE may (re-)enables the S1-mode capability by initiating a Mobility Registration Update (MRU) procedure to update the S1-mode capability from disabled to enabled.

An example of VDM regarding disabled/enabled S1-mode capability of a UE supporting both EPS FB and VoNR is shown (below) in table 1.

TABLE 1

| | NW supports both | NW supports | NW supports |
|---|---|---|---|
| | VoNR and EPS FB | VoNR only | EPS FB only |
| UE disables | UE stays | UE stays | UE switches from |
| S1 mode | in 5G | in 5G | 5G to 2/3G |
| UE then | UE stays | UE stays | UE switches from |
| re-enables | in 5G | in 5G | 2/3G to 5G |
| S1 mode | | | |

An example of VDM regarding disabled/enabled S1-mode capability of a UE supporting EPS FB only is shown (below) in table 2.

TABLE 2

| | NW supports both | NW supports | NW supports |
|---|---|---|---|
| | VoNR and EPS FB | VoNR only | EPS FB only |
| UE disables | UE stays | UE stays | UE switches from |
| S1 mode | in 5G | in 5G | 5G to 2/3G |
| UE then | UE stays | UE stays | UE switches from |
| re-enables | in 5G | in 5G | 2/3G to 5G |
| S1 mode | | | |

An example of VDM regarding disabled/enabled S1-mode capability of a UE supporting VoNR only is shown (below) in table 3.

TABLE 3

| | NW supports both | NW supports | NW supports |
|---|---|---|---|
| | VoNR and EPS FB | VoNR only | EPS FB only |
| UE disables | UE switches from | UE switches from | UE switches from |
| S1 mode | 5G to 2/3G | 5G to 2/3G | 5G to 2/3G |
| UE then | UE switches from | UE switches from | UE switches from |
| re-enables | 2/3G to 5G | 2/3G to 4G | 2/3G to 5G |
| S1 mode | | | |

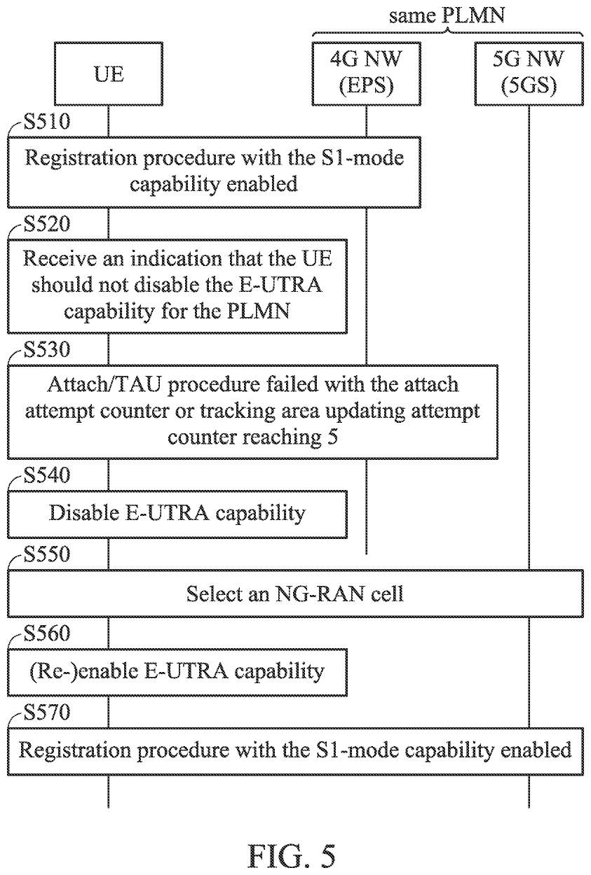

FIG. 5 is a message sequence chart illustrating the provision of an additional indication to enhance the VDM for IMS voice provided over a 5G network according to yet another embodiment of the application.

In step S510, the UE registers to the 4G network with the S1-mode capability enabled.

In step S520, the UE receives an indication that the UE should not disable the E-UTRA capability for the PLMN to which the 4G network belongs.

In one example, the indication may be received via a NAS configuration MO, such as a NAS configuration MO including a “NoEUTRADisablingIn5GS” leaf which indicates whether E-UTRA disabling in 5GS is disabled or enabled. If E-UTRA disabling in 5GS is enabled, the UE should not disable the E-UTRA capability upon starting timer T3402 when the attach attempt counter or tracking area updating attempt counter reaches 5 and the UE selects an NG-RAN cell.

In another example, the indication may be received from a USIM file configured for the PLMN.

In yet another example, the indication may be received via the AT command interface with PLMNs and corresponding voice configuration information (e.g., PLMN A supports VoNR, PLMN B supports voice over fallback to EPS, etc.).

In still another example, the indication may be received via an AS message or a NAS message, such as a REGISTRATION ACCEPT message, a SERVICE ACCEPT message, or a CONFIGURATION UPDATE COMMAND message.

In step S530, the UE performs the attach procedure or the Tracking Area Update (TAU) procedure with the 4G network, but the attach procedure or the TAU procedure fails due to that the attach attempt counter or tracking area updating attempt counter reaches 5 (i.e., the maximum number of reties).

In step S540, the UE disables the E-UTRA capability in response to the attach attempt counter or tracking area updating attempt counter reaching 5.

In step S550, the UE selects an NG-RAN cell (e.g., of a 5G network) in the PLMN (e.g., to which the 5G network belongs).

In step S560, the UE (re-)enables the E-UTRA capability due to that the attach attempt counter or tracking area updating attempt counter reaches 5 and the UE selects an NG-RAN cell.

In step S570, the UE registers to the 5G network by sending a REGISTRATION REQUEST message in which the S1 mode bit is set to “S1 mode supported” in the 5G capability IE and the UE's usage setting IE is set to “voice centric”.

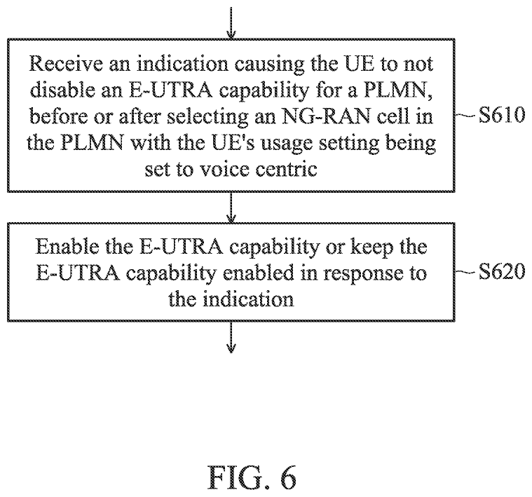

FIG. 6 is a flow chart illustrating the method for a UE to enhance VDM for IMS voice provided over a 5G network according to an embodiment of the application.

In this embodiment, the method is applied to and executed by a UE (e.g., the UE 110).

In step S610, the UE receives an indication causing the UE to not disable an E-UTRA capability for a PLMN, before or after selecting an NG-RAN cell (i.e., a 5G cell) in the PLMN with the UE's usage setting being set to voice centric. Specifically, the UE may have previously received (e.g., during a registration procedure) another indication that the PLMN supports IMS Voice over PS session over 3GPP access, and the received indication in step S610 can be used to inform the UE that IMS voice is served over EPS in the PLMN or that whether VoNR is supported for IMS voice in the PLMN.

In step S620, the UE enables the E-UTRA capability or keeps the E-UTRA capability enabled in response to the indication. In one example, the UE enables the E-UTRA capability in a condition that the E-UTRA capability is disabled for the PLMN. In another example, the UE keeps the E-UTRA capability enabled in a condition that the E-UTRA capability is enabled for the PLMN.

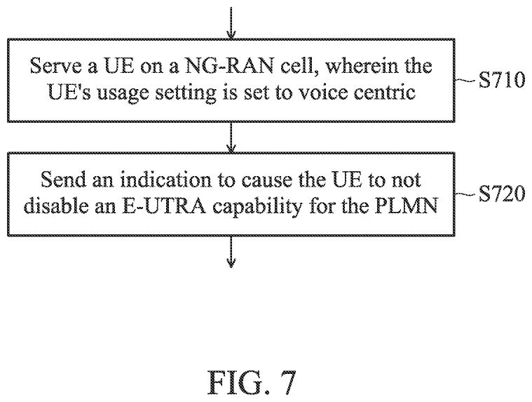

FIG. 7 is a flow chart illustrating the method for a PLMN to enhance VDM for IMS voice provided over a 5G network according to an embodiment of the application.

In this embodiment, the method is applied to and executed by a PLMN which at least includes a 5G network (e.g., the mobile communication network 120).

In step S710, the PLMN serves a UE on a NG-RAN cell, wherein the UE's usage setting is set to voice centric.

In step S720, the PLMN sends an indication to cause the UE to not disable an E-UTRA capability for the PLMN. Specifically, the PLMN may have previously sent (e.g., during a registration procedure) another indication that the PLMN supports IMS Voice over PS session over 3GPP access, and the sent indication in step S720 can be used to inform the UE that IMS voice is served over EPS in the PLMN or that whether VoNR is supported for IMS voice in the PLMN.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A method, comprising:
receiving, by a User Equipment (UE), an indication causing the UE to not disable an Evolved-Universal Terrestrial Radio Access (E-UTRA) capability for a Public Land Mobile Network (PLMN), before or after selecting a Next Generation-Radio Access Network (NG-RAN) cell in the PLMN with the UE's usage setting being set to voice centric; and
enabling the E-UTRA capability or keeping the E-UTRA capability enabled in response to the indication.

2. The method as claimed in claim 1, wherein the enabling of the E-UTRA capability is performed in a condition that the E-UTRA capability is disabled for the PLMN.

3. The method as claimed in claim 2, further comprising:
de-registering from the PLMN and re-registering to the PLMN with the E-UTRA capability enabled; or
initiating a Mobility Registration Update (MRU) procedure to update the E-UTRA capability from disabled to enabled.

4. The method as claimed in claim 1, wherein the keeping of the E-UTRA capability enabled is performed in a condition that the E-UTRA capability is enabled for the PLMN.

5. The method as claimed in claim 1, wherein the indication indicates that IP Multimedia Subsystem (IMS) voice is served over Evolved Packet System (EPS) in the PLMN, or indicates whether Voice over New Radio (VoNR) is supported for IMS voice in the PLMN.

6. The method as claimed in claim 1, further comprising:
receiving another indication that the PLMN supports IMS voice over Packet Switched (PS) session over Third Generation Partnership Project (3GPP) access, when the E-UTRA capability is enabled for the PLMN; or
receiving another indication that the PLMN does not support IMS Voice over PS session over 3GPP access, when the E-UTRA capability is disabled for the PLMN.

7. The method as claimed in claim 1, wherein the indication is received from the PLMN via a Non-Access Stratum (NAS) configuration Management Object (MO).

8. The method as claimed in claim 1, wherein the indication is received from the PLMN via a NAS message which comprises a REGISTRATION ACCEPT message, a SERVICE ACCEPT message, or a CONFIGURATION UPDATE COMMAND message, or via an AS message.

9. The method as claimed in claim 1, wherein the indication is received from a Universal Subscriber Identity Module (USIM) file configured for the PLMN.

10. The method as claimed in claim 1, wherein the indication is received via an Attention (AT) command interface, and the indication comprises information on whether the PLMN supports VoNR or not.

11. A User Equipment (UE), comprising:
a wireless transceiver which, during operation, performs wireless transmission and reception to and from a Public Land Mobile Network (PLMN); and
a controller communicatively coupled to the wireless transceiver such that, during operation, the controller performs operations comprising:
receiving an indication causing the UE to not disable an Evolved-Universal Terrestrial Radio Access (E-UTRA) capability for the PLMN, before or after selecting a Next Generation-Radio Access Network (NG-RAN) cell in the PLMN with the UE's usage setting being set to voice centric; and
enabling the E-UTRA capability or keeping the E-UTRA capability enabled in response to the indication.

12. The UE as claimed in claim 11, wherein the enabling of the E-UTRA capability is performed in a condition that the E-UTRA capability is disabled for the PLMN.

13. The UE as claimed in claim 12, wherein, during operation, the controller further performs operations comprising:
de-registering from the PLMN and re-registering to the PLMN with the E-UTRA capability enabled; or
initiating a Mobility Registration Update (MRU) procedure to update the E-UTRA capability from disabled to enabled.

14. The UE as claimed in claim 11, wherein the keeping of the E-UTRA capability enabled is performed in a condition that the E-UTRA capability is enabled for the PLMN.

15. The UE as claimed in claim 11, wherein the indication indicates that IP Multimedia Subsystem (IMS) voice is served over Evolved Packet System (EPS) in the PLMN, or indicates whether Voice over New Radio (VoNR) is supported for IMS voice in the PLMN.

16. The UE as claimed in claim 11, wherein, during operation, the controller further performs operations comprising:
receiving another indication that the PLMN supports IMS voice over Packet Switched (PS) session over Third Generation Partnership Project (3GPP) access, when the E-UTRA capability is enabled for the PLMN; or
receiving another indication that the PLMN does not support IMS Voice over PS session over 3GPP access, when the E-UTRA capability is disabled for the PLMN.

17. A method, comprising:
serving a User Equipment (UE) on a Next Generation-Radio Access Network (NG-RAN) cell, by a Public Land Mobile Network (PLMN), wherein the UE's usage setting is set to voice centric; and
sending an indication to cause the UE to not disable an Evolved-Universal Terrestrial Radio Access (E-UTRA) capability for the PLMN.

18. The method as claimed in claim 17, further comprising:
sending another indication that the PLMN supports IMS voice over Packet Switched (PS) session over Third Generation Partnership Project (3GPP) access, when the E-UTRA capability is enabled for the PLMN; or
sending another indication that the PLMN does not support IMS Voice over PS session over 3GPP access, when the E-UTRA capability is disabled for the PLMN.

19. The method as claimed in claim 17, wherein the indication indicates that IP Multimedia Subsystem (IMS) voice is served over Evolved Packet System (EPS) in the PLMN, or indicates whether Voice over New Radio (VoNR) is supported for IMS voice in the PLMN.

20. The method as claimed in claim 17, wherein the indication is sent to the UE via a Non-Access Stratum (NAS) configuration Management Object (MO).
